(19) United States
(12) Patent Application Publication
(10) Pub. No.: US 2004/0123477 A1
(43) Pub. Date: Jul. 1, 2004

(54) Sidewalk template book

(76) Inventor: Christopher M. Kauth, Birmingham, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/668,709

(22) Filed: Sep. 23, 2003

Related U.S. Application Data
(60) Provisional application No. 60/412,872, filed on Sep. 23, 2002.

(51) Int. Cl. G01B 3/14

(52) U.S. Cl. 33/562

(57) ABSTRACT

The present invention provides a template book to assist an individual in drawing images or shapes on a drawing surface more accurately than if the individual were to attempt to draw the same images or shapes by freehand. A number of template pages are provided in the form of a template book wherein each template page includes a plurality of foldably attached template sheets which form a drawing template when folded out over a drawing surface.

### RELATED APPLICATION

The present application claims the benefit of U.S. Provisional Application Serial No. 60/412,872 filed Sep. 23, 2002.

### FIELD OF THE INVENTION

The present invention relates to devices that assist a user in drawing images and shapes and, more particularly, to a template book having a plurality of fold-out drawing templates wherein each drawing template is formed of a plurality of foldably attached template sheets.

### BACKGROUND OF THE INVENTION

It is known in the prior art to use preformed templates or stencils for assisting a user in drawing various images and shapes. Such templates are typically provided as substantially rigid sheet materials including cutout portions that define a predetermined image or shape. The user simply positions the template over a marking surface and uses a marker to mark within the cutout portions of the template to create the image or shape on the marking surface in the likeness of the template. In this manner, an individual having very little drawing experience can create images and shapes on a marking surface that appear to have been drawn by a skilled draftsman.

Examples of such prior art tools that assist a user in drawing images and shapes may be found in U.S. Pat. No. 3,900,956 to Furuoka wherein a disc is mounted on a plate, and wherein rotation of the disc relative to the plate provides various composite shape patterns for use in a drawing environment.

U.S. Pat. No. 4,563,154 to Vandervort et al. sets forth a drawing stencil tablet wherein variously configured geometric patterns are positionable upon an underlying surface to permit imparting of such shapes to a drawing surface.

U.S. Pat. No. 6,126,202 issued to Scocca sets forth a book publishing kit that includes two templates and a number of sheets. The sheets include a cover on which a cover template is placed with a cutout from which a drawing can be made. Additional templates are provided for adding various images to the number of sheets as desired for creating a book that includes the template created images and text.

The present invention provides a novel drawing assist tool wherein a user is provided a template book having a plurality of drawing templates foldably disposed within the book as individual pages wherein each page may be folded out from the book and onto a marking surface for assisting a user in drawing an image or shape.

### SUMMARY OF THE INVENTION

The present invention provides a tool for assisting an individual in generating relatively precise images and shapes by using a book having a plurality of foldout templates wherein each template is representative of a predetermined image or shape.

The template book for assisting a user in drawing images and shapes on a surface comprises front and back cover panels formed of a rigid, durable and moisture resistant material wherein the cover panels serve to prolong the life of the book with regard to normal wear and tear, mishandling and exposure.

A plurality of template pages are disposed within the cover panels and are bound thereto in a manner whereby the pages cooperate with the cover panels to present the appearance of a conventional book. Each template page within the cover panels is formed of a plurality of foldably attached template sheets that are adapted to be folded out from the cover panels to form a drawing template. In the folded-out state, each template page remains attached to the cover panels whereby the drawing template may be folded up in a predetermined sequence to once again form a template page within the template book. When folded out, each drawing template covers an area of a drawing surface whereby the area covered by the drawing template is defined by the unfolded template sheets arranged edge to edge in a manner that facilitates the drawing of the predetermined image or shape.

From the foregoing, the user is provided a template book comprising a plurality of template pages operative to be folded out from the book onto a drawing surface wherein each folded out template page represents a drawing template for assisting a user in drawing a predetermined image or shape.

### BRIEF DESCRIPTION OF THE DRAWINGS

A better understanding of the present invention will be had upon reference to the following detailed description when read in conjunction with the accompanying drawings in which like parts are given like reference numerals and wherein:

FIG. 1A illustrates the template book wherein a template page is being folded out from the cover panels;

FIG. 1B illustrates a template book in combination with a plurality of markers and a storage bin;

FIG. 2A illustrates a template page having a plurality of foldably attached template sheets that form a drawing template;

FIG. 2B illustrates a first step of a drawing template being folded up to form a template page within the template book;

FIG. 2C illustrates a second step of a drawing template being folded up to form a template page within the template book; and

FIG. 3 illustrates how the template sheets are foldably attached along predetermined edges to facilitate folding and unfolding of the template pages.

### DETAILED DESCRIPTION OF THE INVENTION

The present invention provides a drawing tool for assisting an individual in generating precise outlines of images and shapes on drawing surfaces such as interior/exterior walls of buildings, floors, sidewalks, driveways, billboards or the like.

According to the invention, an individual folds out a template page from a template book wherein the template page is further unfolded to form a drawing template. The drawing template is disposed on a drawing surface and used to assist the user in drawing the image or shape defined by the template. Thereafter, the drawing template is folded up in a predetermined fashion to form a template page in the template book.

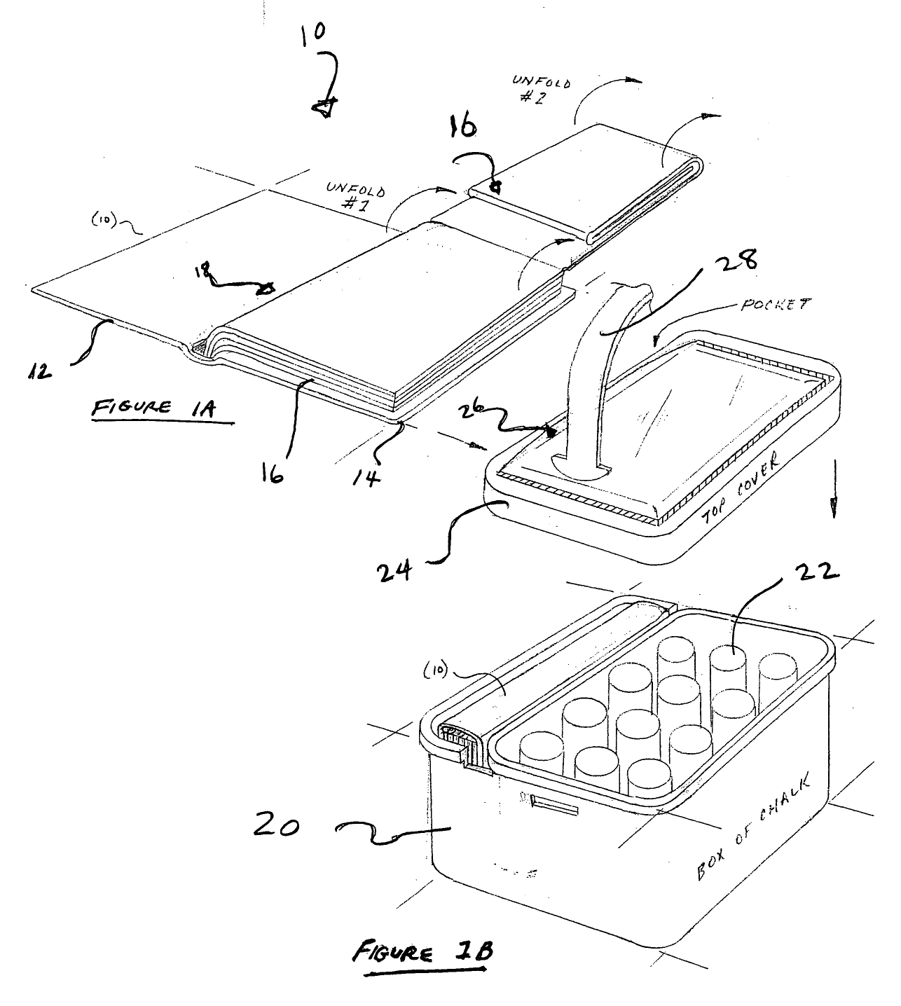

As best illustrated in FIG. 1A, the template book 10 includes front 12 and back 14 cover panels which provide an exterior casing for template pages 16. Preferably, the cover panels are formed of a rigid, durable and moisture resistant material that preserves the useful life of the template book 10. Illustratively, the cover panels may be formed of plastic, laminated sheet materials such as paper or cardboard, and a resilient vinyl material disposed over cardboard. The cover panels are preferably disposed with images and text describing the contents of the template book, as well as the manufacturer's name or trademark, publication date and other information conventionally found on the exterior packaging of most products.

A plurality of template pages 16 are disposed within the cover panels of the template book 10. Preferably, each template page 16 is bound within the front and back cover panels along an elongated edge 18 of a template page 16 in a manner similar to that of a page bound within a conventional book.

Each template page 16 may optionally include a pocket cover for receiving the folded template page 16 therein. The pocket cover is operative to retain the template page 16 in the folded state within the template book 10 when not in use. Preferably, the pocket cover is formed of a transparent plastic material and receives the template page 16 in slip fit engagement. In this manner, each template page 16 can be viewed through the transparent pocket cover for identification. Alternatively, the pocket cover may be opague and disposed with text or mages that describe the template page 10 disposed therein.

It is appreciated that the template book 10 as according to the invention may include one or more template pages 16; however, each template book 10 preferably contains a plurality of template pages 16 for providing the user with a variety of drawing templates.

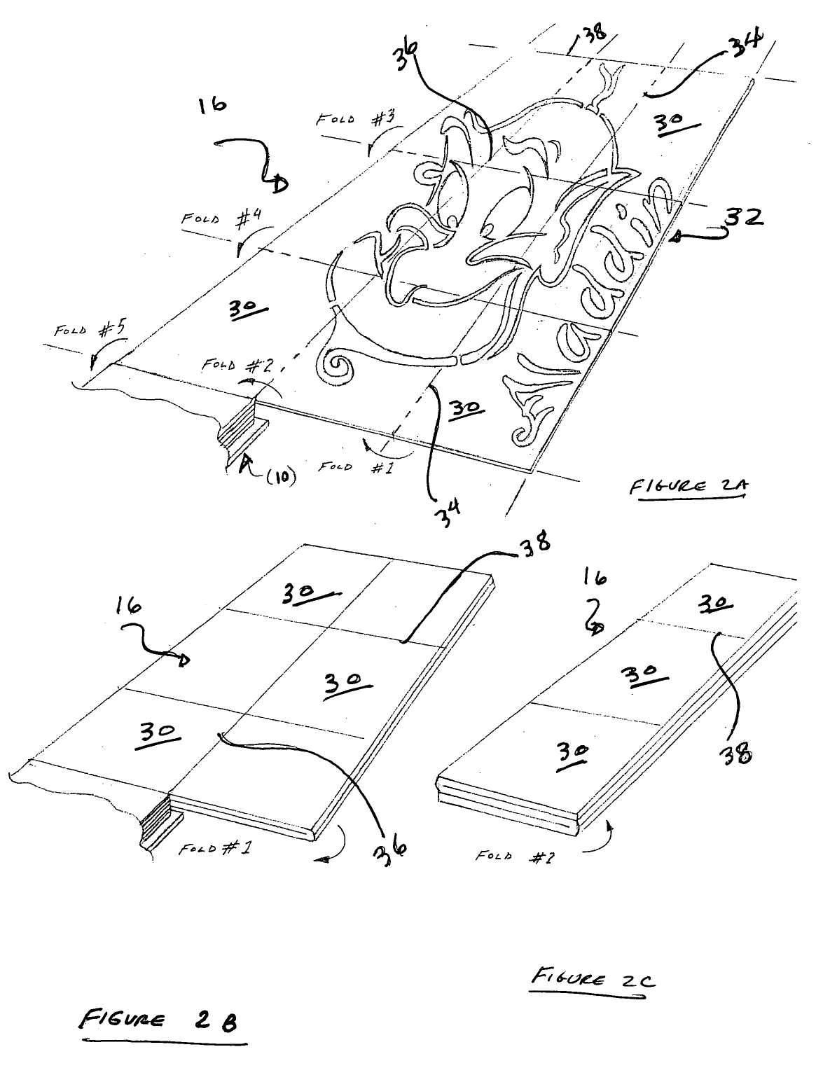

As best illustrated in FIGS. 2A-2C, each template page 16 is comprised of a plurality of foldably attached template sheets 30 that are operative to be folded out onto a drawing surface to form a drawing template 32. Each drawing template 32 covers an area on a drawing surface defined by the combined areas of the template sheets 30 arranged along adjacent edges such that a predetermined image or shape is represented by the combined arrangement of the template sheets 30.

Referring now to FIGS. 2B and 2C, after a user has created an image using the folded-out drawing template 32, the drawing template 32 is folded in a predetermined manner first along fold line 34 (see FIG. 2A), then fold line 36, and thereafter fold line 38 and so on until the drawing template 32 is disposed in the form of a template page 16 as best illustrated in FIG. 1A.

Preferably each template sheet 30 is formed of a durable material such as plastic or laminated sheet material such as cardboard or paper. It is appreciated that other materials may be used for such purpose as long as such material is not readily damaged or destroyed due to normal wear and tear, occasional mishandling, or exposure.

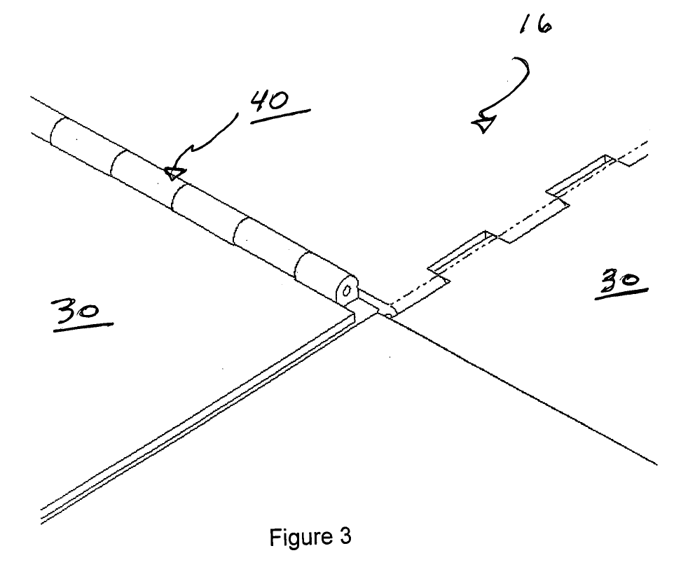

Each of the template sheets 30 are foldably attached along predetermined edges such that the drawing template 32 may be folded out and refolded easily and conveniently by the user as desired. A template sheet 30 may be foldably attached to one or more adjacent along one or more of its edges to facilitate the folding/unfolding process. As illustrated in FIG. 3, a preferred method of foldably attaching the template sheets 30 is by hingedly attaching 40 the respective edges such that a template page 16 can be pivotally folded out to form the drawing template 32. It is appreciated that other attachment means may be resorted to without exceeding the scope of the invention illustratively including ring clips, resiliently pliable thin plastic, woven fabrics, coiled plastic or metal, and nylon string.

With reference to FIG. 1B, the template book 10 may optionally be provided with a storage bin 20 wherein a plurality of markers 22 and the template book 10 may be disposed therein for convenient packaging, storage and transport of the template book 10 and markers 22 as a template kit. Preferably, the storage bin 20 includes a top cover 24 for enclosing the template book 10 and markers 22 therein. The top cover 24 may be provided with a pocket 26 for receiving a portion of the template book, such as a front 12 or back 14 panel, in slip fit engagement whereby the template book 10 may be displayed prominently thereon or made readily available for regular use.

A carrying handle 28 may also be provided with the storage bin 20 for providing the user with a convenient means of transporting the template kit between uses.

The storage bin 20 and top cover 24 may be formed of a moldable plastic material of sufficient strength and durability for protecting the template book 10 and markers 22 against damage when disposed therein. It is appreciated that other materials may be used as may become apparent to those skilled in the art, however, without exceeding the scope of the invention..

The markers 22 are preferably provided in a plurality of colors and may be provided as chalk, ink markers, watercolors, crayons or the like.

In use, the template book 10 is opened like a standard book, and the template pages 16 are comprised of a plurality of thin template sheets foldably attached to the other at predetermined edges to facilitate folding and unfolding. The template sheets 16 are unfolded similar to a map to form a drawing template 32 that covers an area of a drawing surface that is defined by the combined areas of the template sheets 30. Once the template sheets 30 have been folded out, the user simply uses the desired markers 22 to sketch out the image or shape represented by the drawing template 32 and thereafter folds the drawing template 32 back into the template page 16 in the template book 10.

From the foregoing, the present invention provides a drawing tool that assists a user in their artistic ability to draw images and shapes. The invention provides an enjoyable drawing experience for individuals who have not developed the freehand skills necessary for creating the images or shapes provided by the drawing tool. It is appreciated that other embodiments of a template book with template pages that fold out to form drawing templates may become apparent to those skilled in the art in view of the present invention, however, without exceeding the scope of the invention.

I claim:

1. A template book for assisting a user in drawing images and shapes on a surface, said book comprising:
front and back cover panels; and
a plurality of template pages disposed within said cover panels wherein each of said template pages is formed of a plurality of foldably attached template sheets operative to be folded out from said cover panels to form a drawing template, said drawing template having an area defined by said unfolded template sheets.

2. The book of claim 1 wherein said cover panels are formed of a durably rigid material.

3. The book of claim 2 wherein said durably rigid material is formed of cardboard or plastic.

4. The book of claim 1 wherein the plurality of template pages are bound to said cover panels.

5. The book of claim 4 wherein the plurality of template pages are hingedly bound to said cover panels.

6. The book of claim 1 wherein said plurality of foldably attached template sheets are hingedly attached.

7. The book of claim 1 further comprising a storage bin for carrying and storing said book therein.

8. The book of claim 7 further comprising a plurality of markers disposed within said storage bin, said markers operative for use with said drawing template.

9. The book of claim 8 wherein said storage bin further comprises a top cover.

10. The book of claim 9 wherein said top cover includes a pocket for disposing a portion of said book.

11. The book of claim 7 wherein said storage bin further comprises a carrying handle.

12. The book of claim 1 further comprising a pocket cover 19 operative to receive said template page therein.

13. The template kit for assisting a user in drawing images and shapes on a surface, said drawing kit comprising:
a storage bin;
a plurality of markers disposed within said storage bin; and
a template book for use with said markers and disposed within said storage bin, said book comprising:
front and back cover panels; and
a plurality of template pages disposed within said cover panels wherein each of said template pages is formed of a plurality of foldably attached template sheets operative to be folded out from said cover panels to form a drawing template, said drawing template representing an image or shape and having an area defined by said unfolded template sheets.

14. The template kit of claim 13 wherein said storage bin further comprises a top cover.

15. The template kit of claim 14 wherein said top cover further comprises a pocket for disposing a portion of said template book.

16. The template kit of claim 13 wherein said storage bin further comprises a carrying handle.

17. The template kit of claim 13 further comprising a pocket cover 19 operative to receive said template page therein.
